(19) United States
(12) Patent Application Publication
(10) Pub. No.: US 2025/0252890 A1
(43) Pub. Date: Aug. 7, 2025

(54) GATE DRIVING CIRCUIT, DRIVING METHOD, DISPLAY PANEL, AND DISPLAY DEVICE

(71) Applicant: Xiamen Tianma Optoelectronics Co., Ltd., Xiamen (CN)

(72) Inventor: Tomohiko OTOSE, Xiamen (CN)

(73) Assignee: Xiamen Tianma Optoelectronics Co., Ltd., Xiamen (CN)

(21) Appl. No.: 19/184,442

(22) Filed: Apr. 21, 2025

(30) Foreign Application Priority Data
Dec. 27, 2024 (CN) 202411958694.X

(51) Int. Cl. G09G 3/20

(52) U.S. Cl. CPC G09G 3/2092; G09G 2300/0842; G09G 2310/0267; G09G 2310/061; G09G 2310/08

(57) ABSTRACT

A gate driving unit of a gate driving circuit includes a pull-up node control circuit configured to control a potential of a pull-up node, a pull-down node control circuit including a pull-down node control transistor electrically connected to a pull-down node, and a gate driving output circuit configured to control a gate driving signal under the control of voltage signals of the pull-up node and the pull-down node. The pull-down node control circuit controls the potential of a pull-down node under the control of a control voltage signal, a fixed voltage signal, and a voltage signal of the pull-up node. The control voltage signal of the gate is less than the fixed voltage signal of the drain of the pull-down node control transistor, or the fixed voltage signal of the gate is less than the control voltage signal of the drain of the pull-down node control transistor.

### CROSS-REFERENCE TO RELATED APPLICATION(S)

This application claims priority to Chinese Patent Application No. 202411958694.X filed Dec. 27, 2024, the disclosure of which is incorporated herein by reference in its entirety.

### TECHNICAL FIELD

Embodiments of this application relate to the field of display technology, particularly a gate driving circuit, a driving method, a display panel, and a display device.

### BACKGROUND

In the related art, a gate driving circuit (which may also be referred to as a gate driver on array (GOA) circuit) includes multiple cascaded gate driving units. The driving signal output end of each gate driving unit corresponds to one gate line to achieve progressive scanning of a display panel.

Currently, in a gate driving unit, it is required to consider the driving capability of the transistor responsible for controlling the potential of a pull-up node. Typically, the area of the transistor is large when designed, causing the gate driving circuit to occupy a large space in the bezel area of the display panel and affecting the narrow bezel design of the panel.

### SUMMARY

This application provides a gate driving circuit, a driving method, a display panel, and a display device.

In one aspect, one or more embodiments of this application provide a gate driving circuit. The gate driving circuit includes multiple gate driving units. A gate driving unit includes a pull-up node control circuit, a pull-down node control circuit, and a gate driving output circuit.

The pull-up node control circuit is configured to control the potential of a pull-up node.

The pull-down node control circuit is configured to control the potential of a pull-down node under the control of a voltage signal of the pull-up node, a control voltage signal, and a fixed voltage signal.

The gate driving output circuit is configured to control a gate driving signal output by a gate driving signal output terminal of the gate driving unit under the control of the voltage signal of the pull-up node and a voltage signal of the pull-down node.

The pull-down node control circuit includes a pull-down node control transistor. A first electrode of the pull-down node control transistor is electrically connected to the pull-down node.

The gate of the pull-down node control transistor is configured to receive the control voltage signal, a second electrode of the pull-down node control transistor is configured to receive the fixed voltage signal, and the control voltage signal V and the fixed voltage signal VDC satisfy V<VDC for at least part of the time of a driving process of the gate driving circuit; or the gate of the pull-down node control transistor is configured to receive the fixed voltage signal, a second electrode of the pull-down node control transistor is configured to receive the control voltage signal, and the fixed voltage signal VDC and the control voltage signal V satisfy VDC<V for at least part of the time of a driving process of the gate driving circuit.

In another aspect, one or more embodiments of this application provide a driving method of a gate driving circuit. The method is applied to the gate driving circuit of any embodiment of this application. The driving process of the gate driving circuit includes a first output stage and a second output stage.

The driving method includes, in the first output stage, controlling, by the pull-up node control circuit, the potential of the pull-up node to be an active level; and controlling, by the gate driving output circuit, the gate driving signal output by the gate driving signal output terminal to be a first gate driving signal under the control of the voltage signal of the pull-up node; and in the second output stage, controlling, by the pull-down node control circuit, the potential of the pull-down node to be an active level under the control of the voltage signal of the pull-up node, the control voltage signal, and the fixed voltage signal; and controlling, by the gate driving output circuit, the gate driving signal output by the gate driving signal output terminal to be a second gate driving signal under the control of the voltage signal of the pull-down node.

In another aspect, one or more embodiments of this application provide a display device. The display device includes the gate driving circuit of any embodiment of this application.

### BRIEF DESCRIPTION OF DRAWINGS

FIG. 1 is a diagram illustrating the structure of a gate driving unit in the related art.

FIG. 2 is a circuit diagram of the gate driving unit of FIG. 1.

FIG. 3 is a timing diagram of the driving signals of the gate driving unit of FIG. 2.

FIG. 4 is a diagram of a gate driving circuit according to one or more embodiments of this application.

FIG. 5 is a diagram illustrating the structure of a gate driving unit according to one or more embodiments of this application.

FIG. 6 is a diagram illustrating the structure of a gate driving unit according to one or more embodiments of this application.

FIG. 7 is a flowchart of a driving method of a gate driving circuit according to one or more embodiments of this application.

FIG. 8 is a timing diagram of the driving signals of the gate driving unit of FIG. 5 and the driving signals of the gate driving unit of FIG. 6.

FIG. 9 is a diagram illustrating the structure of another gate driving unit according to one or more embodiments of this application.

FIG. 10 is a diagram illustrating the structure of another gate driving unit according to one or more embodiments of this application.

FIG. 11 is a flowchart of a driving method of another gate driving circuit according to one or more embodiments of this application.

FIG. 12 is a timing diagram of the driving signals of the gate driving unit of FIG. 9 and the driving signals of the gate driving unit of FIG. 10.

FIG. 13 is a diagram illustrating the structure of another gate driving unit according to one or more embodiments of this application.

FIG. 14 is a diagram illustrating the structure of another gate driving unit according to one or more embodiments of this application.

FIG. 15 is a diagram illustrating the structure of another gate driving unit according to one or more embodiments of this application.

FIG. 16 is a diagram illustrating the structure of another gate driving unit according to one or more embodiments of this application.

FIG. 17 is a diagram illustrating the structure of a display device according to one or more embodiments of this application.

### DETAILED DESCRIPTION

This application is further described in detail below in conjunction with the drawings and embodiments. The embodiments described herein are used to illustrate this application and not to limit this application. Additionally, for ease of description, only part, not all, of structures related to this application are illustrated in the drawings.

Terms used in the embodiments of this application are used to describe the embodiments and not to limit this application. For example, nouns of locality, including “up”, “down”, “left”, and “right” used in the embodiments of this application, are described from the perspective of the drawings and are not to be construed as a limitation to the embodiments of this application. In addition, in the context, when a component is formed “on” or “below” another component, the component may not be directly formed “on” or “below” another component but may also be indirectly formed “on” or “below” another component via an intermediate component. Terms such as “first” and “second” are used for description to distinguish between different components and not to indicate any order, quantity, or importance. For those of ordinary skill in the art, specific meanings of the preceding terms in this application may be based on specific situations.

The terms “comprise”, “include”, and variations thereof in this application are used to be inclusive, that is, “including, but not limited to”. The term “based on” is “at least partially based on”. The term “an embodiment” refers to “at least one embodiment”.

References to “first”, “second”, and the like in this application are used to distinguish corresponding content and are not intended to limit order or an interrelationship.

“One” and “Plurality”/“Multiple” mentioned in this application are illustrative and not limiting, and those skilled in the art should understand that “one” and “plurality”/“multiple” should be “one or more” unless clearly indicated in the context.

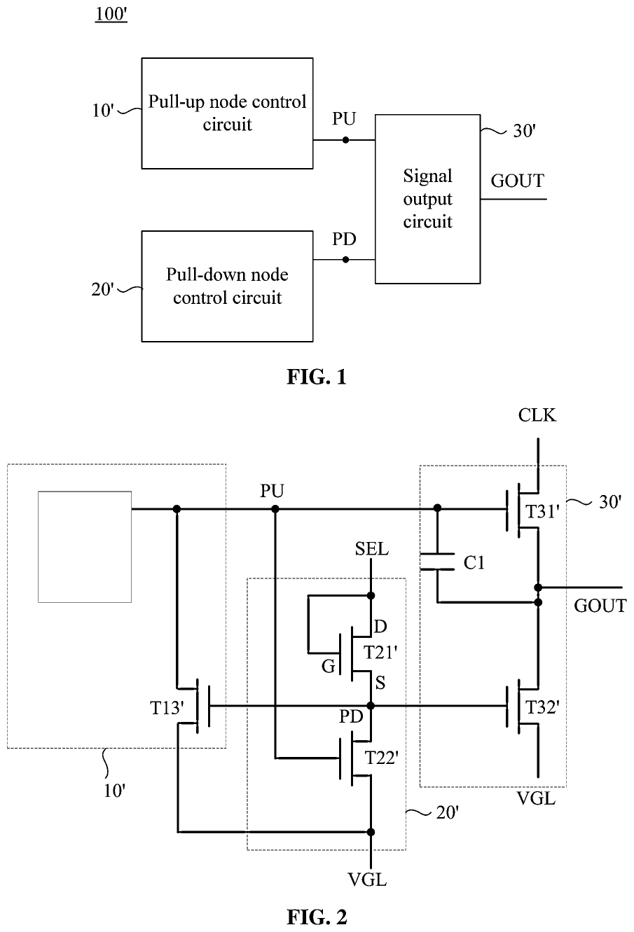

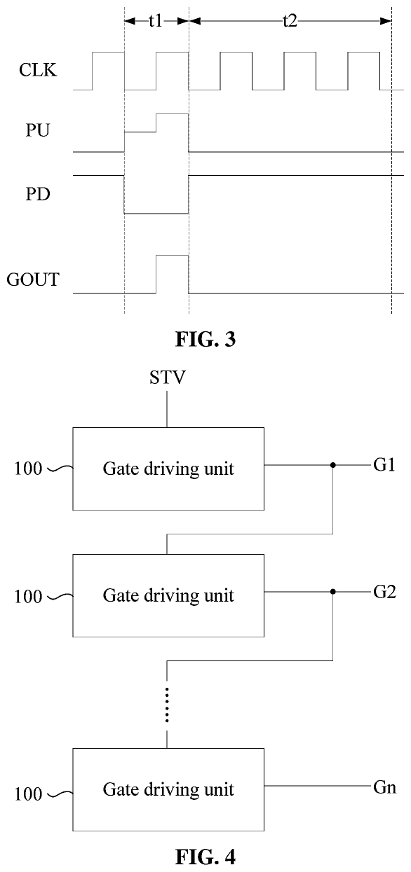

FIG. 1 is a diagram illustrating the structure of a gate driving unit in the related art. FIG. 2 is a circuit diagram of the gate driving unit of FIG. 1. FIG. 3 is a timing diagram of the driving signals of the gate driving unit of FIG. 2. Referring to FIG. 1 to FIG. 3, in the related art, the gate driving unit 100′ may include a pull-up node control circuit 10′, a pull-down node control circuit 20′, and a gate signal output circuit 30′. The gate signal output circuit 30′ includes a first output transistor T31′ and a second output transistor T32′. The gate of the first output transistor T31′ is connected to a pull-up node PU, a first electrode of the first output transistor T31′ is connected to a clock signal CLK, and a second electrode of the first output transistor T31′ is connected to an output terminal GOUT. The pull-up node control circuit 10′ is configured to control the potential of the pull-up node PU, that is, control the gate potential of the first output transistor T31′ to control the first output transistor T31′ to turn on so that when the clock signal CLK is a high-level signal VGH, the high-level signal VGH is output to implement a pull-up process of the output signal GOUT. The gate of the second output transistor T32′ is connected to a pull-down node PD, a first electrode of the second output transistor T32′ is connected to the output terminal GOUT, and a second electrode of the second output transistor T32′ is connected to a low-level voltage signal VGL. The pull-down node control circuit 20′ is configured to control the potential of the pull-down node PD, that is, control the gate potential of the second output transistor T32′, thereby controlling the second output transistor T32′ to turn on to output a low-level voltage signal VGL to achieve the pull-down process of the output signal GOUT. As can be seen from the above, the gate driving unit 100′ essentially achieves output control through the cooperation of the pull-up node control circuit 10′ controlling the pull-up node PU and the pull-down node control circuit 20′ controlling the pull-down node PD.

As shown in FIG. 2, the pull-down node control circuit 20′ may include a first transistor T21′ and a second transistor T22′. The pull-up node control circuit 10′ is provided with a third transistor T13′. These transistors are all N-type channel transistors. The gate G and the first electrode (drain D) of the first transistor T21′ are each connected to a pull-down node control signal SEL. A second electrode (source S) of the first transistor T21′ is connected to a first electrode of the second transistor T22′. The connection node forms the pull-down node PD. The gate of the second transistor T22′ is connected to the pull-up node PU, and a second electrode of the second transistor T22′ is connected to a low-level voltage signal terminal VGL. The third transistor T13′ has a gate connected to the pull-down node PD, a first electrode connected to the pull-up node PU, and a second electrode connected to the low-level voltage signal terminal VGL.

The pull-down node control signal SEL is always a high-level signal so as to form a gate-source voltage difference between the gate G and the second electrode (that is, the source S) of the first transistor T21′, thereby controlling the first transistor T21′ to be continuously on. Therefore, in the pull-down process the output signal GOUT, that is, in stage t2 shown in FIG. 3, the first transistor T21′ is in an On state, and the pull-down node PD receives the pull-down node control signal SEL, that is, a high-level signal, to control the third transistor T13′ to turn on so that the pull-up node PU is supplied with the low-level voltage signal VGL, and the pull-up node PU controls the second transistor T22′ to turn off. In this process, the pull-down node PD is in a high-level state, the second output transistor T32′ can be controlled to turn on, the pull-up node PU is in a low-level state, the first output transistor T31′ can be controlled to turn off, and the output signal GOUT outputs a low-level voltage signal to implement the pull-down process of the output signal GOUT.

On the contrary, in the pull-up process of the output signal GOUT, that is, in the stage t1 as shown in FIG. 3, the pull-down node PD is in a low-level state, the second output transistor T32′ is controlled to turn off, the pull-up node PU is controlled by the pull-up node control circuit 10′ to be in a high-level state, and the first output transistor T31′ is controlled to turn on. The output signal GOUT outputs a high-level voltage signal when the clock signal CLK is a high-level signal to implement the pull-up process of the output signal GOUT.

During the pull-up process of the output signal GOUT, since the pull-up node PU is in a high-level state, the second transistor T22′ is controlled to turn on. Meanwhile, under the control of the high-level pull-down node control signal SEL, the first transistor T21′ generates a gate-source voltage difference and is always in an On state so that the pull-down node control signal SEL and the low-level voltage signal terminal VGL form a series path through the first transistor T21′, the pull-down node PD, and the second transistor T22′. In this case, the potential of the pull-down node PD depends on the current driving capability of the first transistor T21′ and the current driving capability of the second transistor T22′. To ensure that the pull-down node PD is in a low-level state and the second output transistor T32′ is turned off in the pull-up process of the output signal GOUT, the second transistor T22′ is required to have a stronger current driving capability. In addition, the ratio of the current driving capability of the second transistor T22′ to the current driving capability of the first transistor T21′ is usually designed to be more than 10 times, otherwise, it cannot be ensured that the potential of the pull-down node PD is pulled down, causing that the second output transistor T32′ cannot be turned off and affecting the high-level output of the output signal GOUT.

In summary, when the second transistor T22′ and the first transistor T21′ are prepared, the size of the second transistor T22′ is required to be designed to be relatively large to achieve a relatively large current driving capability. Apparently, due to the large size of the second transistor T22′, that is, since at least one large-size transistor is required to be designed for each gate driving unit 100′, and the gate driving circuit generally requires multiple gate driving units 100′ to be cascaded, this circuit design results in a large occupied area of the circuit, affecting the overall area of the bezel area of the display panel and being not conducive to a narrow bezel design.

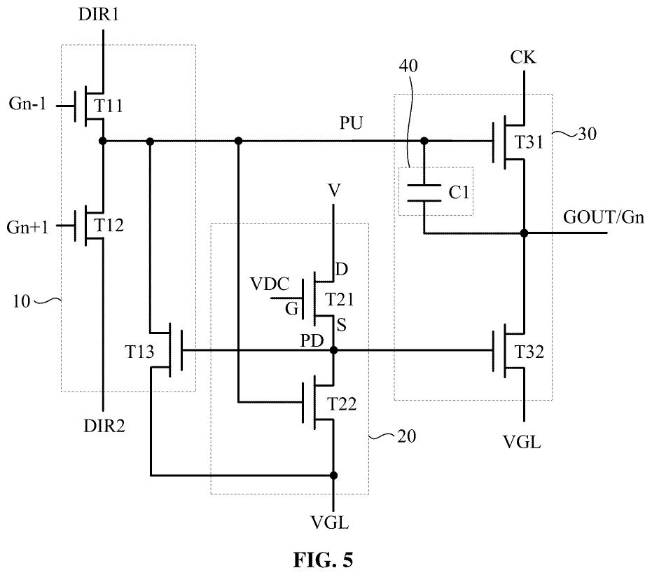

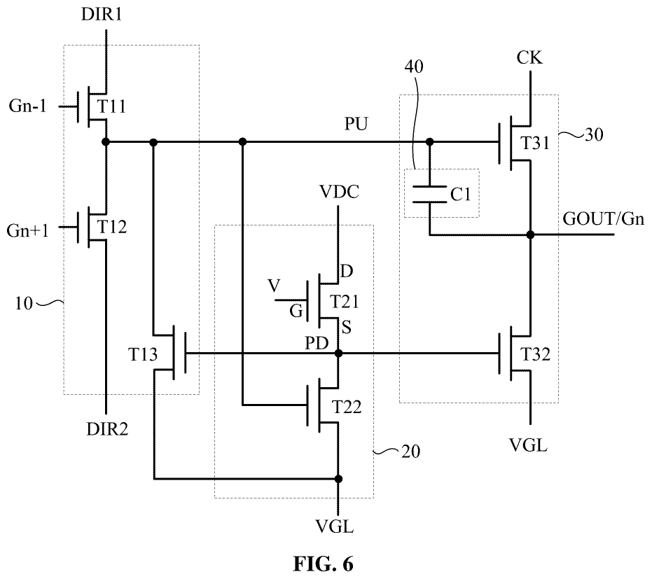

Embodiments of this application provide a gate driving circuit. FIG. 4 is a diagram of a gate driving circuit according to one or more embodiments of this application. FIG. 5 and FIG. 6 are diagrams illustrating the structures of another two gate driving units according to one or more embodiments of this application. Referring to FIG. 4 to FIG. 6, the gate driving circuit includes multiple gate driving units 100. Each gate driving unit 100 includes a pull-up node control circuit 10 configured to control the potential of a pull-up node PU; and a pull-down node control circuit 20 configured to control the potential of a pull-down node PD under the control of a voltage signal of the pull-up node PU, a control voltage signal, and a fixed voltage signal. The pull-down node control circuit 20 includes a pull-down node control transistor T21. A first electrode, that is, the source S, of the pull-down node control transistor T21 is electrically connected to the pull-down node PD. The gate G of the pull-down node control transistor T21 is configured to receive the control voltage signal; a second electrode, that is, the drain D, of the pull-down node control transistor T21 is configured to receive the fixed voltage signal; and the fixed voltage signal VDC and the control voltage signal V satisfy V<VDC for at least part of the time of a driving process of the gate driving circuit. Alternatively, the gate G of the pull-down node control transistor T21 is configured to receive the fixed voltage signal; the second electrode, that is, the drain D, is configured to receive the control voltage signal; and the fixed voltage signal VDC and the control voltage signal V satisfy VDC<V for at least part of the time of a driving process of the gate driving circuit. The gate driving output circuit 30 is configured to control a gate driving signal output by a gate driving signal output terminal GOUT of a gate driving unit under the control of the voltage signal of the pull-up node PU and a voltage signal of the pull-down node PD.

In a display panel, using an organic light-emitting display panel as an example, a display area is provided with multiple pixel units each of which is composed of a pixel circuit and a light-emitting element. The pixel circuit drives the light-emitting element to emit light. In this manner, an image is displayed through the cooperation of the pixel units. The gate driving circuit of one or more embodiments of this application is applied to a display panel and is responsible for providing a gate driving signal to a transistor in a pixel circuit in a display area to control the pixel circuit to drive the light-emitting element to emit light. In one or more embodiments, each gate driving unit 100 in the gate driving circuit of one or more embodiments of this application may be configured to provide the gate driving signal GOUT to the pixel circuits in the same row of pixel units to achieve the driving control of the pixel units in this row. The gate driving units 100 are configured to sequentially provide gate driving signals to the respective row of pixel units, thereby achieving progressive scanning and completing the display of one frame of image based on the visual residual effect of human eyes.

In one or more embodiments of this application, the gate driving unit 100 generates and outputs the gate driving signal GOUT through the gate driving output circuit 30. The gate driving output circuit 30 is controlled by voltage signals of two nodes, that is, the pull-up node PU and the pull-down node PD. In one or more embodiments, the pull-up node PU is responsible for controlling the gate driving signal GOUT output by the gate driving circuit 30 to be pulled up to a high-level voltage signal, and the pull-down node PD is responsible for controlling the gate driving signal GOUT output by the gate driving circuit 30 to be pulled down to a low-level voltage signal. The pull-up node PU and the pull-down node PD are provided with a pull-up node control circuit 10 for potential control and a pull-down node control circuit 20 for potential control respectively.

In one or more embodiments of this application, the pull-down node control circuit 20 includes a pull-down node control transistor T21. The pull-down node control transistor T21 is an N-type channel transistor. The source S of the pull-down node control transistor T21 is connected to the pull-down node PD. On this basis, as shown in FIG. 5, in one or more embodiments, the gate G of the pull-down node control transistor T21 may be configured to receive the fixed voltage signal VDC, and the drain D of the pull-down node control transistor T21 may be configured to receive the control voltage signal V. The fixed voltage signal VDC received by the gate G is set to be less than the control voltage signal V received by the drain D; compared with the case where the gate and the drain receive the pull-down node control signal SEL simultaneously, the voltage difference between the gate G and the source S can be reduced on the basis that the transistor is turned on. It can be inferred from the positive correlation between the conduction current of the transistor and the gate-source voltage difference that the conduction current of the transistor can be reduced, and thus the current driving capability of the pull-down node control transistor T21 can be lowered.

Similarly, as shown in FIG. 6, in another embodiment, the gate G of the pull-down node control transistor T21 may be configured to receive the control voltage signal V, and the drain D of the pull-down node control transistor T21 may be configured to receive the fixed voltage signal VDC. Thus, the control voltage signal V received by the gate G is set to be less than the fixed voltage signal VDC received by the drain D so that, compared with the case where the gate and the drain receive the same signal simultaneously, the voltage difference between the gate G and the source S can be reduced so that the conduction current of the transistor can be reduced, and the current driving capability of the pull-down node control transistor T21 can be reduced.

As described earlier, when the pull-down node control transistor T21 is connected in series with another pull-down node control transistor T22 as shown in FIG. 5, the source of the pull-down node control transistor T22 is connected to the low-level voltage signal VGL, and the connection node forms the pull-down node PD, after the series branch is turned on, to ensure that the pull-down node PD can still be at a low-level voltage, the current driving capability of the pull-down node control transistor T22 is required to be stronger than that of the pull-down node control transistor T21. In one or more embodiments of this application, by reducing the voltage of the input signal of the gate of the pull-down node control transistor T21, it is possible to reduce the current driving capability of the pull-down node control transistor T21 and reduce the current driving capability of the pull-down node control transistor T22. This can reduce the size of the transistor, especially the pull-down node control transistor T22, on the series branch during actual preparation, reduce the occupied area of the gate driving unit, reduce the bezel area of the display panel, and achieve a narrow bezel design.

In the related art, the gate and the drain of the pull-down node control transistor T21 receive the pull-down node control signal SEL simultaneously. The high-level voltage of the SEL signal is generally 15 V. The voltage of the source, i.e., the voltage of the pull-down node PD, is a low-level voltage of −10 V. The threshold voltage of the transistor is 1.5 V. Therefore, when the pull-down node control transistor T21 is turned on, the gate-source voltage difference Vgs=VGH−Vth−VGL=15 V−1.5 V−(−10 V)=23.5 V. In one or more embodiments of this application, using the embodiment shown in FIG. 5 as an example, the gate of the pull-down node control transistor T21 is configured to receive the fixed voltage signal VDC that may be set to 5V, and the drain of the pull-down node control transistor T21 is configured to receive the control voltage signal V. The high-level voltage is also 15 V. The voltage of the source, that is, the voltage of the pull-down node, is also −10 V. Therefore, when the pull-down node control transistor T21 is turned on, the gate-source voltage difference of the pull-down node control transistor T21 is Vgs=VDC−Vth−VGL=5 V−1.5 V−(−10 V)=13.5 V. It can be seen from the comparison that the gate-source voltage difference of the pull-down node control transistor T21 in one or more embodiments of this application is lower. On this basis, the pull-down node control transistor T22 does not require an excessively high current driving capability, and the ratio of the width-to-length ratio of the pull-down node control transistor T22 to the width-to-length ratio of the pull-down node control transistor T21 can be appropriately reduced, for example, reduced from 2.5 to 3 times, to 1.6 to 2 times, thereby reducing the size of the two transistors and reducing the occupied area of the gate driving unit.

It is to be additionally noted that in one or more embodiments of this application, the configuration that the control voltage signal V and the fixed voltage signal VDC satisfy V<VDC for at least part of the time or satisfy V>VDC for at least part of the time essentially means that the voltage signal transmitted on the control voltage signal V can change with time, and in the stage in which the pull-down node control transistor T21 and the other pull-down node control transistor T22 are each turned on to form a series path, it is ensured that the gate voltage is higher than the source voltage and appropriately lower than the voltage of the drain input signal so that the gate-source voltage difference of the pull-down node control transistor T21 can be reduced. This reduces the conduction current so that when the series path is turned on, because the other pull-down node control transistor T22 has a larger current driving capability, the voltage of the pull-down node PD is pulled down through the low-level voltage signal VGL connected to the source thereof, thereby controlling the gate driving output circuit.

In the solution of one or more embodiments, the gate driving circuit includes multiple gate driving units. Each gate driving unit includes a pull-up node control circuit, a pull-down node control circuit, and a gate driving output circuit. The pull-up node control circuit is configured to control the potential of a pull-up node. The pull-down node control circuit is configured to control the potential of a pull-down node under the control of a voltage signal of the pull-up node, a control voltage signal, and a fixed voltage signal. The gate driving output circuit is configured to control a gate driving signal output by a gate driving signal output terminal under the control of the voltage signal of the pull-up node and a voltage signal of the pull-down node. The pull-down node control circuit includes a pull-down node control transistor. A source of the pull-down node control transistor is electrically connected to the pull-down node. The gate of the pull-down node control transistor is configured to receive the control voltage signal, a drain of the pull-down node control transistor is configured to receive the fixed voltage signal, and the control voltage signal V and the fixed voltage signal VDC satisfy V<VDC for at least part of the time of a driving process of the gate driving circuit; or the gate of the pull-down node control transistor is configured to receive the fixed voltage signal, a drain of the pull-down node control transistor is configured to receive the control voltage signal, and the fixed voltage signal VDC and the control voltage signal V satisfy VDC<V for at least part of the time of a driving process of the gate driving circuit. The embodiments of this application solve the problem that the narrow bezel design of a display panel is affected by excessive space occupation by the gate driving circuit in the bezel area of the display panel. A lower voltage signal is applied to the gate of the pull-down node control transistor of the pull-down node control circuit compared with a voltage signal applied to the drain of the pull-down node control transistor of the pull-down node control circuit. This can reduce the conduction current of the pull-down node control transistor, decrease the current driving capability of the pull-down node control transistor, reduce the size of the transistor of the pull-down node control circuit, reduce the occupied area of the gate driving unit, reduce the bezel area of the display panel, and achieve a narrow bezel design.

In addition, the gate driving circuit of one or more embodiments of this application can be applied to an organic light-emitting display panel and can also be applied to, for example, a liquid crystal display (LCD) panel, a quantum dot display (QLED) panel, or a micro light-emitting diode (Micro-LED) panel. This is not limited here.

With continued reference to FIG. 5 and FIG. 6, in one or more embodiments, the gate driving units 100 are cascaded in sequence; the pull-up node control circuit 10 includes a first pull-up node control transistor T11 and a second pull-up node control transistor T12; a second electrode, that is, the drain, of the first pull-up node control transistor T11 is configured to receive a forward scan control signal DIR1, a first electrode, that is, the source, of the first pull-up node control transistor T11 is connected to the pull-up node PU, and the gate of the first pull-up node control transistor T11 is configured to receive the gate driving signal Gₙ₋₁ output by the gate driving signal output terminal of the cascaded previous-stage gate driving unit 100; and a second electrode, that is, the drain, of the second pull-up node control transistor T12 is configured to receive a reverse scan control signal DIR2, a first electrode, that is, the source, of the second pull-up node control transistor T12 is connected to the pull-up node PU, and the gate of the second pull-up node control transistor T12 is configured to receive the gate driving signal Gₙ₊₁ output by the gate driving signal output terminal of the cascaded next-stage gate driving unit. In the same gate driving unit 100, the polarity of the forward scan control signal DIR1 is opposite to the polarity of the reverse scan control signal DIR2. Further, the pull-up node control circuit 10 also includes a pull-up node control transistor T13. A second electrode, that is, the drain, of the pull-up node control transistor T13 is connected to the pull-up node PU, a first electrode, that is, the source, of the pull-up node control transistor T13 is configured to receive a first power signal, and the gate of the pull-up node control transistor T13 is connected to the pull-down node PD. The first power signal may be a low-level voltage signal VGL.

With continued reference to FIG. 5 and FIG. 6, in one or more embodiments, the gate driving output circuit 30 includes a first output control transistor T31 and a second output control transistor T32. A second electrode, that is, the drain, of the first output control transistor T31 is configured to receive a clock signal CK, a first electrode, that is, the source, of the first output control transistor T31 is connected to the gate driving signal output terminal GOUT, and the gate of the first output control transistor T31 is connected to the pull-up node PU. A second electrode, that is, the drain, of the second output control transistor T32 is connected to the gate driving signal output terminal GOUT, a first electrode, that is, the source, of the second output control transistor T32 is configured to receive the first power signal, and the gate of the second output control transistor T32 is connected to the pull-down node PD. Similarly, the first power signal may be a low-level voltage signal VGL.

With continued reference to FIG. 5 and FIG. 6, further in one or more embodiments, the gate driving output circuit 30 also includes an energy storage circuit 40. The energy storage circuit 40 is connected to the pull-up node PU and configured to maintain the potential of the pull-up node PU. In one or more embodiments, the energy storage circuit 40 includes a storage capacitor C1. A first plate of the storage capacitor C1 is connected to the pull-up node PU, and a second plate of the storage capacitor C1 is connected to the gate driving signal output terminal GOUT.

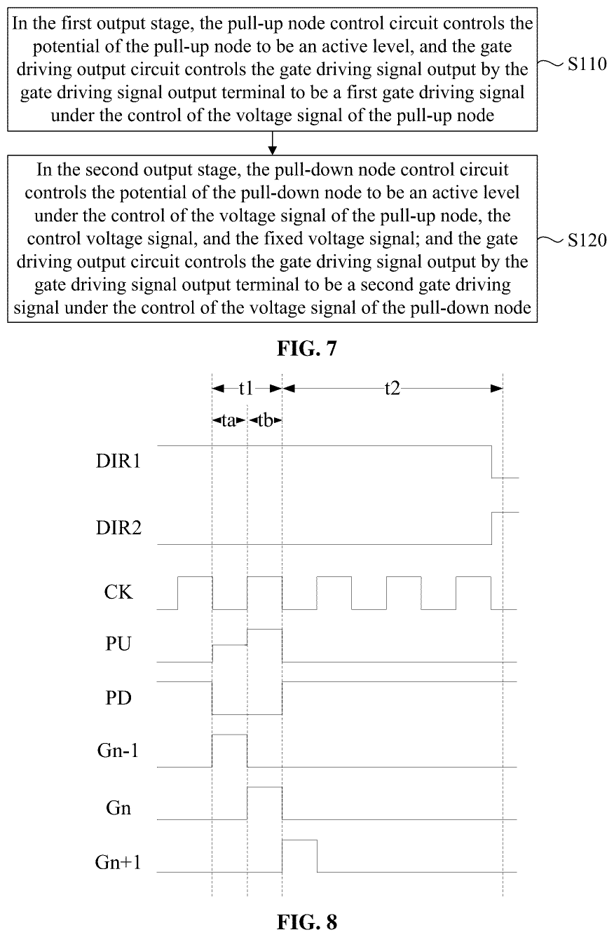

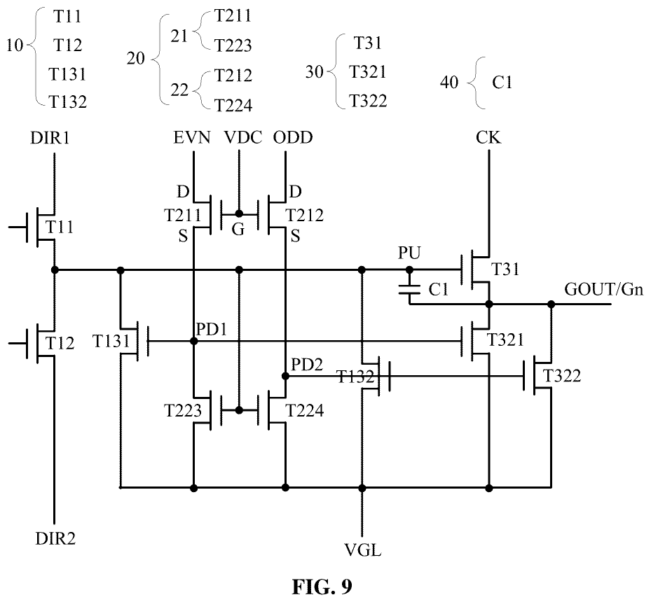

Based on the gate driving circuit of the previous embodiments, one or more embodiments of this application provide a driving method of a gate driving circuit. In one or more embodiments, the driving process of the gate driving circuit includes a first output stage t1 and a second output stage t2. FIG. 7 is a flowchart of a driving method of a gate driving circuit according to one or more embodiments of this application. FIG. 8 is a timing diagram of the driving signals of the gate driving unit of FIG. 5 and the driving signals of the gate driving unit of FIG. 6. Referring to FIG. 7 and FIG. 8, the driving method may include S110 and S120.

In S110, in the first output stage, the pull-up node control circuit controls the potential of the pull-up node to be an active level, and the gate driving output circuit controls the gate driving signal output by the gate driving signal output terminal to be a first gate driving signal under the control of the voltage signal of the pull-up node.

Based on that the energy storage circuit 40 is disposed in the gate driving output circuit 30, the first output stage t1 is divided into an input stage ta and an output stage tb. In the input stage, the pull-up node control circuit charges the energy storage circuit through the pull-up node. In the output stage, the energy storage circuit performs bootstrap discharge to maintain the potential of the pull-up node at an active level, and the gate driving output circuit controls the gate driving signal output by the gate driving signal output terminal to be the first gate driving signal under the control of the voltage signal of the pull-up node.

In one or more embodiments, referring to FIG. 5 and FIG. 6, since the first output control transistor T31 is an N-type channel transistor, the active level of the pull-up node PU is a high level. That is, when the pull-up node PU is at a high level, the first output control transistor T31 is turned on. In the driving timing shown in FIG. 8, by way of example, the forward scan control signal DIR1 is a high-level signal, and the reverse scan control signal DIR2 is a low-level signal. In the input stage ta of the first output stage t1, that is, when the previous-stage gate driving signal Gₙ₋₁ is at a high level, the first pull-up node control transistor T11 is turned on, and the forward scan control signal DIR1 is applied to the pull-up node PU to charge the storage capacitor C1. In the output stage tb of the first output stage t1, that is, when the previous-stage gate driving signal Gₙ₋₁ is at a low level, the storage capacitor C1 performs bootstrap discharge so that the pull-up node PU is pulled up to a high level, that is, the active level of the first output control transistor T31, to control the first output control transistor T31 to turn on. Therefore, in the output stage tb of the first output stage t1, the first output control transistor T31 is turned on and is responsible for outputting the clock signal CK as the first gate driving signal. At this time, when the clock signal CK is at a high level, the current-stage gate driving signal Gₙ is output at a high level.

In addition, in the first output stage t1, the pull-up node PU at a high level can correspondingly control the pull-down node control transistor T22 to turn on, and the pull-down node control transistors T21 and T22 that are always in an On state form a series path; since the current driving capability of the pull-down node control transistor T22 is set to be much greater than that of T21, the pull-down node PD approaches the low-level voltage signal VGL, that is, the pull-down node PD is at a low level, and the pull-down node PD is at an inactive level at this time, and the second output control transistor T32 is controlled to turn off.

In S120, in the second output stage, the pull-down node control circuit controls the potential of the pull-down node to be an active level under the control of the voltage signal of the pull-up node, the control voltage signal, and the fixed voltage signal; and the gate driving output circuit controls the gate driving signal output by the gate driving signal output terminal to be a second gate driving signal under the control of the voltage signal of the pull-down node.

Referring to FIG. 5 and FIG. 6, since the second output control transistor T32 is an N-type channel transistor, the active level of the pull-down node PD is also a high level. That is, the second output control transistor T32 is turned on when the pull-down node PD is at a high level. With continued reference to FIG. 8, in the second output stage t2, the discharging of the storage capacitor C1 ends, and the pull-up node PU is at a low level, thereby controlling the first output control transistor T31 to turn off. Therefore, in the second output stage t2, the pull-up node PU is at a low level and correspondingly controls the pull-down node control transistor T22 to turn off, and the pull-down node control transistor T21 that is always in an On state inputs its drain signal to the pull-down node PD. In the embodiment shown in FIG. 5, the pull-down node PD receives the control voltage signal V. In the embodiment shown in FIG. 6, the pull-down node PD receives the fixed voltage signal VDC. Both of the two voltage signals are high-level signals, that is, the pull-down node PD is at a high level in this stage and as an active level, controls the second output control transistor T32 to turn on and is responsible for outputting the low-level voltage signal VGL as the second gate driving signal.

It can be seen from the preceding two stages that for the gate driving unit, the active pulse of the previous-stage gate driving signal Gₙ₋₁ serves as the control pulse, an active pulse in the clock signal CK delayed by one pulse period relative to the control pulse serves as the output of the current-stage gate driving signal Gₙ, and the pulse signal of the current-stage gate driving signal Gₙ has a delay of one pulse period relative to the previous-stage gate driving signal Gₙ₋₁, that is, the shift function is achieved. The cascaded gate driving units 100 can achieve a sequential shift output according to the previous-stage gate driving signal Gₙ₋₁ of each gate driving unit 100.

In addition, it is to be noted that it can be seen from the preceding circuit working principle that the forward scan control signal DIR1 actually achieves the process of sequentially shifting and driving the gate driving units 100 from the previous stage to the next stage, that is, in the display panel, a progressive scanning process from top to bottom can be achieved. In the pull-up node control circuit 10, the second pull-up node control transistor T12 is also provided. The gate of the second pull-up node control transistor T12 receives the next-stage gate driving signal Gₙ₊₁. The source of the second pull-up node control transistor T12 receives the reverse scan control signal DIR2. This is essentially a process of sequentially shifting and driving from the next stage to the previous stage through the reverse scan control signal DIR2, that is, a progressive scanning process from bottom to top. When progressive scanning is performed from bottom to top, the reverse scan control signal DIR2 may be changed to a high-level signal, and the forward scan control signal DIR1 may be changed to a low-level signal. In the process of backward scanning from bottom to top, the working principle is the same as that of forward scanning. This is not be repeated here.

In addition, it is to be noted that in the forward scanning process from top to bottom, there is no previous-stage gate driving unit 100 for the first-stage gate driving unit 100, so the gate of the first pull-up node control transistor T11 is actually configured to receive a trigger signal STV, and the gate driving signal of each stage of gate driving unit is shifted and output through the trigger signal STV. Similarly, in the reverse scanning process from bottom to top, there is no next-stage gate driving unit 100 for the last-stage gate driving unit 100, so the gate of the first pull-up node control transistor T11 is also configured to receive the trigger signal STV, and the gate driving signal of each stage of gate driving unit is shifted and output through the trigger signal STV.

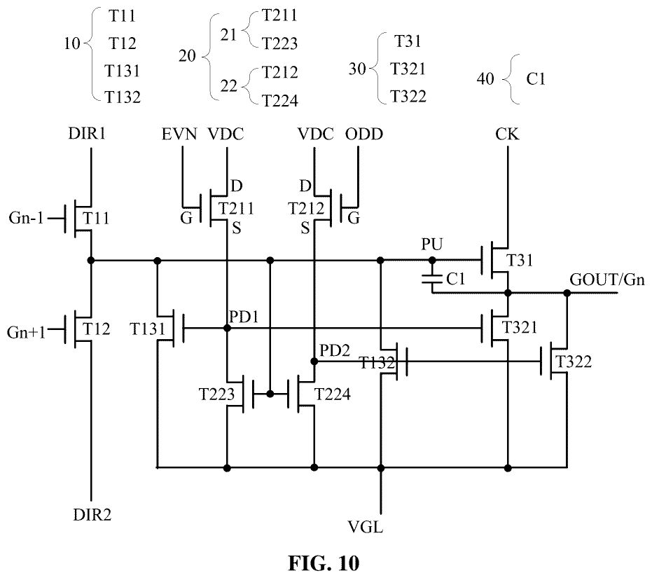

FIG. 9 and FIG. 10 are diagrams illustrating the structures of another two gate driving units according to one or more embodiments of this application. Referring to FIG. 9 and FIG. 10, in the gate driving unit, the pull-down node PD includes a first pull-down node PD1 and a second pull-down node PD2; the pull-down node control circuit 20 includes a first pull-down node control circuit 21 and a second pull-down node control circuit 22; the control voltage signal includes a first control voltage signal EVN and a second control voltage signal ODD; the first pull-down node control circuit 21 is configured to control the potential of the first pull-down node PD1 under the control of the voltage signal of the pull-up node PU, the first control voltage signal EVN and the fixed voltage signal VDC; and the second pull-down node control circuit 22 is configured to control the potential of the second pull-down node PD2 under the control of the voltage signal of the pull-up node PU, the second control voltage signal ODD and the fixed voltage signal VDC.

The first pull-down node control circuit 21 includes a first pull-down node control transistor T211, and a first electrode, that is, the source S, of the first pull-down node control transistor T211 is electrically connected to the first pull-down node PD1. The gate G of the first pull-down node control transistor T211 receives the fixed voltage signal VDC, and a second electrode, that is, the drain D, of the first pull-down node control transistor T211 receives the first control voltage signal EVN, as shown in FIG. 9; or the gate G of the first pull-down node control transistor T211 receives the first control voltage signal EVN, and a second electrode, that is, the drain D, of the first pull-down node control transistor T211 receives the fixed voltage signal VDC, as shown in FIG. 10.

The second pull-down node control circuit 22 includes a second pull-down node control transistor T212. A first electrode, that is, the source S, of the second pull-down node control transistor T212 is electrically connected to the second pull-down node PD2. The gate G of the second pull-down node control transistor T212 receives the fixed voltage signal VDC, and a second electrode, that is, a drain D, of the second pull-down node control transistor T212 receives the second control voltage signal ODD, as shown in FIG. 9; or the gate G of the second pull-down node control transistor T212 receives the second control voltage signal ODD, and a second electrode, that is, the drain D, of the second pull-down node control transistor T212 receives the fixed voltage signal VDC, as shown in FIG. 10. The first control voltage signal EVN and the second control voltage signal ODD alternate between the first voltage and the second voltage over time. One of the first control voltage signal EVN or the second control voltage signal ODD is the first voltage V1. The other of the first control voltage signal EVN or the second control voltage signal ODD is the second voltage V2. V1<V2.

The gate driving output circuit is configured to control the gate driving signal output by the gate driving signal output terminal GOUT under the control of the voltage signal of the pull-up node PU, the voltage signal of the first pull-down node PD1, and the voltage signal of the second pull-down node PD2.

In one or more embodiments, the second output control transistor in the gate driving output circuit 30 may include a first sub-output control transistor T321 and a second sub-output control transistor T322. The gate of the first sub-output control transistor T321 is electrically connected to the first pull-down node PD1, the drain of the first sub-output control transistor T321 is connected to the gate driving signal output terminal GOUT, and the source of the first sub-output control transistor T321 is connected to the first power signal. The gate of the second sub-output control transistor T322 is electrically connected to the second pull-down node PD2, the drain of the second sub-output control transistor T322 is connected to the gate driving signal output terminal GOUT, and the source of the second sub-output control transistor T322 is connected to the first power signal.

In the two embodiments as shown in FIG. 9 and FIG. 10, the first pull-down node control circuit 21 and the second pull-down node control circuit 22 are essentially configured to control the potential of the first pull-down node PD1 and the potential of the second pull-down node PD2 respectively. The two pull-down nodes alternately control the pull-down process of the gate driving signal GOUT output by the gate driving output circuit 30. The alternating control principle and process are not described in detail here. It can be understood that in the first pull-down node control circuit 21 and the second pull-down node control circuit 22, their circuit structures are completely the same. For the gate driving unit, the two pull-down node control circuits can provide a gate-source voltage difference for the first pull-down node control transistor T211 and the second pull-down node control transistor T212 and appropriately reduce the gate voltage to reduce the conduction current of the two pull-down node control transistors and reduce the current driving capability of the two pull-down node control transistors, thereby helping to reduce the current driving capability of the pull-down node control transistors that are connected in series with the two pull-down node control transistors respectively, thereby reducing the size of the transistor and reducing the occupied area of the gate driving unit.

With continued reference to FIG. 9 and FIG. 10, further, the fixed voltage signal VDC, the first voltage V1, and the second voltage V2 satisfy V1<VDC<V2.

In the embodiment shown in FIG. 9, the first pull-down node control circuit 21 also includes a third pull-down node control transistor T223, and the second pull-down node control circuit 22 also includes a fourth pull-down node control transistor T224. The gate G of the first pull-down node control transistor T211 and the gate G of the second pull-down node control transistor T212 are each configured to receive the fixed voltage signal VDC. A second electrode, that is, the drain D, of the first pull-down node control transistor T211 receives the first control voltage signal EVN. A second electrode, that is, the drain D, of the second pull-down node control transistor T212 receives the second control voltage signal ODD. A second electrode, that is, the drain, of the third pull-down node control transistor T223 is connected to the first pull-down node PD1. A second electrode, that is, the drain, of the fourth pull-down node control transistor T224 is connected to the second pull-down node PD2. The gate of the third pull-down node control transistor T223 and the gate of the fourth pull-down node control transistor T224 are each connected to the pull-up node PU. A first electrode, that is, the source, of the third pull-down node control transistor T223 and a first electrode, that is, the source, of the fourth pull-down node control transistor T224 are each configured to receive the first power signal.

In the embodiment shown in FIG. 10, the first pull-down node control circuit 21 also includes a third pull-down node control transistor T223, and the second pull-down node control circuit 22 also includes a fourth pull-down node control transistor T224. A second electrode, that is, the drain D, of the first pull-down node control transistor T211 and a second electrode, that is, the drain D, of the second pull-down node control transistor T212 are each configured to receive the fixed voltage signal VDC. The gate G of the first pull-down node control transistor T211 receives the first control voltage signal EVN. The gate of the second pull-down node control transistor T212 receives the second control voltage signal ODD. A second electrode, that is, the drain, of the third pull-down node control transistor T223 is connected to the first pull-down node PD1. A second electrode, that is, the drain, of the fourth pull-down node control transistor T224 is connected to the second pull-down node PD2. The gate of the third pull-down node control transistor T223 and the gate of the fourth pull-down node control transistor T224 are each connected to the pull-up node PU. A first electrode, that is, the source, of the third pull-down node control transistor T223 and a first electrode, that is, the source, of the fourth pull-down node control transistor T224 are each configured to receive the first power signal.

In addition, in the embodiments shown in FIG. 9 and FIG. 10, the ratio of the width-to-length ratio of the third pull-down node control transistor T223 to the width-to-length ratio of the first pull-down node control transistor T211 ranges from 1.6 to 2; and/or the ratio of the width-to-length ratio of the fourth pull-down node control transistor T224 to the width-to-length ratio of the second pull-down node control transistor T213 ranges from 1.6 to 2. Therefore, the third pull-down node control transistor T223 may have a higher current driving capability than the first pull-down node control transistor T211. Moreover, compared with the first pull-down node control transistor T211, the third pull-down node control transistor T223 is not required to have an excessively large size, thereby reducing the size of the two transistors and reducing the occupied area of the gate driving unit. Similarly, the fourth pull-down node control transistor T224 may have a higher current driving capability than the second pull-down node control transistor T212. Moreover, compared with the second pull-down node control transistor T212, the fourth pull-down node control transistor T224 is not required to have an excessively large size, thereby reducing the size of the two transistors and reducing the occupied area of the gate driving unit.

It is to be noted here that as shown in FIG. 9 and FIG. 10, the first power signal may be a low-level voltage signal VGL responsible for pulling down the potential of the first pull-down node PD1 when the third pull-down node control transistor T223 is turned on or pulling down the potential of the second pull-down node PD2 when the fourth pull-down node control transistor T224 is turned on.

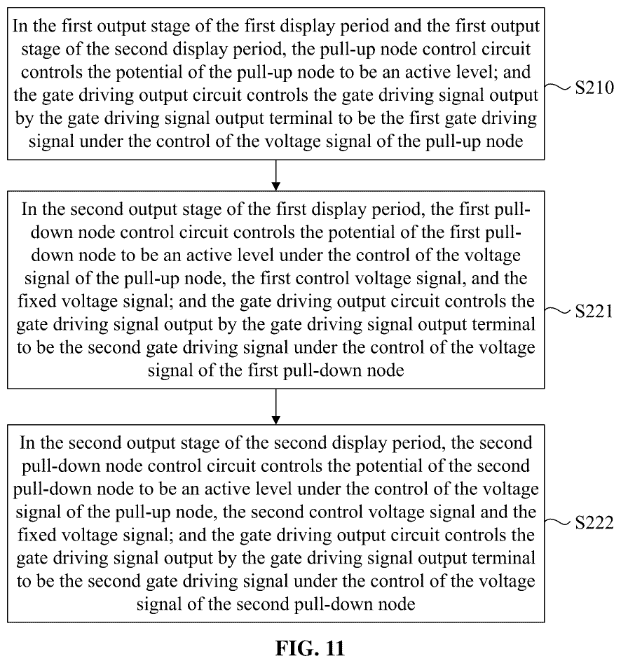

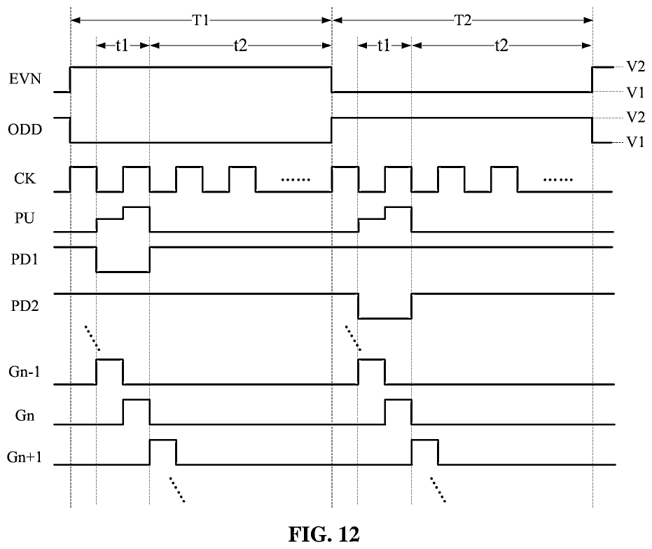

Based on the two types of gate driving circuits shown in FIG. 9 and FIG. 10, one or more embodiments of this application provide a driving method of a gate driving circuit. FIG. 11 is a flowchart of a driving method of a gate driving circuit according to one or more embodiments of this application. FIG. 12 is a timing diagram of the driving signals of the gate driving unit of FIG. 9 and the driving signals of the gate driving unit of FIG. 10. Referring to FIG. 11 and FIG. 12, first, the driving process of the gate driving circuit may include a first display period T1 and a second display period T2. The first display period T1 and the second display period T2 each include a first output stage t1 and a second output stage t2. The first display period T1 may be a display period in which the first pull-down node control circuit 21 performs a pull-down function. The second display period T2 may be a display period in which the second pull-down node control circuit 22 performs a pull-down action. The two display periods may be alternately arranged to implement alternating operation and alternating rest of the two pull-down node control circuits, avoiding electrical drift caused by continuous operation of the transistors.

The alternating operation of the two pull-down node control circuits is substantially implemented by a controlling manner of the first control voltage signal EVN and the second control voltage signal ODD. Referring to FIG. 9, FIG. 10, and FIG. 12, the first control voltage signal EVN and the second control voltage signal ODD alternate between the first voltage V1 and the second voltage V2 over time. The first voltage V1 may be a low-level voltage VGL. The second voltage V2 may be a high-level voltage VGH. The two control voltage signals alternate between the high-level voltage and the low-level voltage. The low-level voltage signal VGL is received at the source of the third pull-down node control transistor T223 and the source of the fourth pull-down node control transistor T224, thus the high-level voltage signal of the pull-down node is achieved mainly by the first pull-down node control transistor T211 and the second pull-down node control transistor T212 being connected conducted to transmit the high-level voltage signal to the first pull-down node PD1 and the second pull-down node PD2 respectively. That is, the pull-down action of the pull-down node control circuit is controlled by whether the first pull-down node control transistor T211 or the second pull-down node control transistor T212 is turned on. Using the first pull-down node control circuit 21 performing pull-down as an example, when the first control voltage signal EVN is converted into a high-level voltage signal, the first pull-down node control transistor T211 is controlled to turn on so that the high-level voltage signal can be applied to the first pull-down node PD1 through the first pull-down node control transistor T211 so that the first pull-down node control circuit 21 can perform a pull-down action. At the same time, since the second control voltage signal ODD is a low-level voltage signal at this time, the second pull-down node control transistor T212 is turned off so that the second pull-down node PD2 cannot be supplied with a high-level voltage signal and cannot perform a pull-down action, that is, enter a rest state.

Based on the preceding circuit structure, the driving method of one or more embodiments may include S210, S221, and S222.

In S210, in the first output stage of the first display period and the first output stage of the second display period, the pull-up node control circuit controls the potential of the pull-up node to be an active level; and the gate driving output circuit controls the gate driving signal output by the gate driving signal output terminal to be the first gate driving signal under the control of the voltage signal of the pull-up node.

The first display period T1 indicates that there is a display period in which the first pull-down node control circuit 21 performs the pull-down action, and the second display period T2 indicates that there is a display period in which the second pull-down node control circuit 22 performs the pull-down action. Moreover, as described earlier, in the first output stage t1 of the gate driving unit, the pull-up node control circuit 10 inputs the high-level voltage signal VGH, that is, an active level, to the pull-up node PU and performs the pull-up action. In this stage, under the control of the previous-stage gate driving signal Gₙ₋₁, the first output control transistor T31 is turned on, and the gate driving signal output terminal GOUT outputs the clock signal CK as the first gate driving signal.

In addition, the high-level pull-up node PU controls the third pull-down node control transistor T223 and the fourth pull-down node control transistor T224 to turn on. Regardless of whether the first pull-down node control transistor T211 and the second pull-down node control transistor T212 are turned on, that is, regardless of the first display period T1 or the second display period T2, since the current driving capability of the third pull-down node control transistor T223 is much greater than the current driving capability of the first pull-down node control transistor T211, and the current driving capability of the fourth pull-down node control transistor T224 is much greater than the current driving capability of the second pull-down node control transistor T212, the first power signal, that is, the low-level voltage signal VGL (that is, an inactive level), is applied to the first pull-down node PD1 and the second pull-down node PD2 to control the first sub-output control transistor T321 and the second sub-output control transistor T322 to turn off.

In S221, in the second output stage of the first display period, the first pull-down node control circuit controls the potential of the first pull-down node to be an active level under the control of the voltage signal of the pull-up node, the first control voltage signal, and the fixed voltage signal; and the gate driving output circuit controls the gate driving signal output by the gate driving signal output terminal to be the second gate driving signal under the control of the voltage signal of the first pull-down node.

In the first display period T1, that is, in the display period in which the first pull-down node control circuit 21 performs the pull-down action, the second output stage t2 of the gate driving unit is a stage in which the first pull-down node control circuit 21 inputs the high-level voltage signal VGH to the first pull-down node PD1 to perform the pull-down action. In this stage, the third pull-down node control transistor T223 is turned off under the control of the pull-up node PU switched to a low level.

In the embodiment shown in FIG. 9, the gate of the first pull-down node control transistor T211 receives the fixed potential signal VDC, and the fixed potential signal VDC is greater than the low-level voltage signal VGL, so that the first pull-down node control transistor T211 generates a gate-source voltage difference and is turned on. In the embodiment shown in FIG. 10, the gate of the first pull-down node control transistor T211 receives the first control voltage signal EVN, and at this time, the first control voltage signal EVN is a high-level voltage signal VGH that is greater than the low-level voltage signal VGL, so that the first pull-down node control transistor T211 generates a gate-source voltage difference and is turned on.

The turned-on first pull-down node control transistor T211 supplies the first control voltage signal EVN to the first pull-down node PD1. At this time, the first control voltage signal EVN is a high-level voltage signal VGH, that is, an active level. The high-level first pull-down node PD1 controls the first sub-output control transistor T321 to turn on. The gate driving signal output terminal GOUT outputs the first power signal, that is, the low-level voltage signal VGL, as the second gate driving signal.

In S222, in the second output stage of the second display period, the second pull-down node control circuit controls the potential of the second pull-down node to be an active level under the control of the voltage signal of the pull-up node, the second control voltage signal and the fixed voltage signal; and the gate driving output circuit controls the gate driving signal output by the gate driving signal output terminal to be the second gate driving signal under the control of the voltage signal of the second pull-down node.

In the second display period T2, that is, in the display period in which the second pull-down node control circuit 22 performs the pull-down action, the second output stage t2 of the gate driving unit is a stage in which the second pull-down node control circuit 22 inputs the high-level voltage signal VGH to the second pull-down node PD2 to perform the pull-down action. The fourth pull-down node control transistor T224 is turned off under the control of the pull-up node PU switched to a low level.

In the embodiment shown in FIG. 9, the gate of the second pull-down node control transistor T212 receives the fixed potential signal VDC, and the fixed potential signal VDC is greater than the low-level voltage signal VGL, so that the second pull-down node control transistor T212 generates a gate-source voltage difference and is turned on. In the embodiment shown in FIG. 10, the gate of the second pull-down node control transistor T212 receives the second control voltage signal ODD, and at this time, the second control voltage signal ODD is a high-level voltage signal VGH that is greater than the low-level voltage signal VGL, so that the first pull-down node control transistor T211 generates a gate-source voltage difference and is turned on.

The turned-on second pull-down node control transistor T212 supplies the second control voltage signal ODD to the second pull-down node PD2. At this time, the second control voltage signal ODD is a high-level voltage signal VGH, that is, an active level. The high-level second pull-down node PD2 controls the second sub-output control transistor T322 to turn on. The gate driving signal output terminal GOUT outputs the first power signal, that is, the low-level voltage signal VGL, as the second gate driving signal.

Further, the driving method of the preceding embodiment may also include S223 and S224.

In S223, in the second output stage of the first display period, the second pull-down node control circuit controls the potential of the second pull-down node to be an inactive level under the control of the voltage signal of the pull-up node, the second control voltage signal, and the fixed voltage signal.

In the first display period T1, that is, in the display period in which the first pull-down node control circuit 21 performs the pull-down action, the second output stage t2 of the gate driving unit is also the stage in which the second pull-down node control circuit 22 inputs the low-level voltage signal VGL to the second pull-down node PD2 to stop performing the pull-down action. In this stage, the fourth pull-down node control transistor T224 is turned off under the control of the pull-up node PU switched to a low level.

In the embodiment shown in FIG. 9, the gate of the second pull-down node control transistor T212 receives the fixed potential signal VDC, and the fixed potential signal VDC is greater than the low-level voltage signal VGL, so that the second pull-down node control transistor T212 generates a gate-source voltage difference and is turned on. The turned-on second pull-down node control transistor T212 supplies the second control voltage signal ODD to the second pull-down node PD2 to control the second sub-output control transistor T322 to turn off. At this time, the second control voltage signal ODD is a low-level voltage signal VGL, that is, an inactive level.

In the embodiment shown in FIG. 10, the gate of the second pull-down node control transistor T212 receives the second control voltage signal ODD, and at this time, the second control voltage signal ODD is the low-level voltage signal VGL, so that the second pull-down node control transistor T212 is turned off due to the gate-source voltage difference generated being lower than the threshold voltage. Since the second pull-down node control transistor T212 and the fourth pull-down node control transistor T224 are both turned off, the second pull-down node PD2 cannot receive the high-level voltage signal VGH and is in a floating state. The second pull-down node PD2 maintains the low-level voltage signal VGL input in the previous stage, that is, the first output stage t1. The second pull-down node PD2 is in a low-level state, that is, the second pull-down node PD2 is at an inactive level, and the second sub-output control transistor T322 is also controlled to turn off.

In S224, in the second output stage of the second display period, the first pull-down node control circuit controls the potential of the first pull-down node to be an inactive level under the control of the voltage signal of the pull-up node, the first control voltage signal, and the fixed voltage signal.

In the second display period T2, that is, in a display period in which the second pull-down node control circuit 22 performs the pull-down action, the second output stage t2 of the gate driving unit is also a stage in which the first pull-down node control circuit 21 inputs the low-level voltage signal VGL to the first pull-down node PD1 to stop performing the pull-down action. In this stage, the third pull-down node control transistor T223 is turned off under the control of the pull-up node PU switched to a low level.

In the embodiment shown in FIG. 9, the gate of the first pull-down node control transistor T211 receives the fixed potential signal VDC, and the fixed potential signal VDC is greater than the low-level voltage signal VGL, so that the first pull-down node control transistor T211 generates a gate-source voltage difference and is turned on. The turned-on first pull-down node control transistor T211 supplies the first control voltage signal EVN to the first pull-down node PD1. At this time, the first control voltage signal EVN is a low-level voltage signal VGL, that is, an inactive level, and the first sub-output control transistor T321 is controlled to turn off.

In the embodiment shown in FIG. 10, the gate of the first pull-down node control transistor T211 receives the first control voltage signal EVN, and at this time, the first control voltage signal EVN is the low-level voltage signal VGL, so that the first pull-down node control transistor T211 is turned off due to the gate-source voltage difference generated being lower than the threshold voltage. Since the first pull-down node control transistor T211 and the third pull-down node control transistor T223 are both turned off, the first pull-down node PD1 cannot receive the high-level voltage signal VGH and is in a floating state. At this time, the first pull-down node PD1 maintains the low-level voltage signal VGL input in the previous stage, that is, the first output stage t1. The first pull-down node PD1 is in a low-level state, that is, an inactive level, and the first sub-output control transistor T321 is also controlled to turn off.

In summary, in the first output stage t1 in which the first control voltage signal EVN and the second control voltage signal ODD are alternately switched, the outputting of the high-level voltage signal of the gate driving signal GOUT is controlled by the pull-up node control circuit 10, the outputting of the low-level voltage signal is controlled by the first pull-down node control circuit 21, and the second pull-down node control circuit 22 does not work. Similarly, in the second output stage t2, after the high-level voltage signal and the low-level voltage signal of the first control voltage signal EVN and the second control voltage signal ODD are changed, the outputting of the low-level voltage signal of the gate driving signal GOUT is changed to be controlled by the second pull-down node control circuit 22, and the first pull-down node control circuit 21 does not work. It can be seen that in one or more embodiments, with the arrangement of the first pull-down node control circuit 21 and the second pull-down node control circuit 22 and under the control of the first control voltage signal EVN and the second control voltage signal ODD, the alternating operation of the two pull-down node control circuits is achieved so that the first pull-down node control transistor T211 and the second pull-down node control transistor T212 can be intermittently turned on by the voltage-variable control signal, thereby reducing the risk of DC bias, avoiding the problem of threshold voltage drift generated when the two transistors are under a fixed bias for a long time, and ensuring the accuracy and stability of the pull-down process of the gate driving signal GOUT.

In addition, for a solution in which the voltage-variable first control voltage signal EVN is input to the gate and the source of the first pull-down node control transistor T211 simultaneously and the voltage-variable second control voltage signal ODD is input to the gate and the source of the second pull-down node control transistor T212 simultaneously, when the first pull-down node control circuit 21 is controlled to work and the second pull-down node control circuit 22 is controlled to stop, the first pull-down node control transistor T211 is turned on, and the second pull-down node control transistor T212 is turned off; and when the first pull-down node control circuit 21 is controlled to stop and the second pull-down node control circuit 22 is controlled to work, the first pull-down node control transistor T211 is turned off, and the second pull-down node control transistor T212 is turned on. If any one of the pull-down node control transistors is turned off, using that the first pull-down node control circuit 21 works and the second pull-down node control transistor T212 is turned off as an example, the pull-up node PU is at a low-level voltage signal VGL, the fourth pull-down node control transistor T224 is also turned off, the second node PD2 is thus in a floating state, the potential of the second node PD2 changes under external interference, there is a risk of changing to a high-level voltage signal to pull down the gate driving signal OUT of the gate driving output circuit 30, thereby causing the problem that the second pull-down node control circuit 22 to continue working in a work stopping stage, that is, the problem of poor stopping state. However, in the embodiment shown in FIG. 9, the gate of the first pull-down node control transistor T211 and the gate of the second pull-down node control transistor T212 are each connected to the DC fixed voltage signal VDC. The two pull-down node control transistors are always in an On state. In a stage in which the first pull-down node control circuit 21 works, the second pull-down node control circuit 22 stops working, and the pull-up node PU is in the low-level state, that is, in the second output stage t2 of the first display period T1, even if the third pull-down node control transistor T223 and the fourth pull-down node control transistor T224 are turned off under the control of the pull-up node PU switched to the low level, the second pull-down node PD2 can still receive the low-level second control voltage signal ODD through the second pull-down node control transistor T212 so that the low-level voltage signal can be supplied to the second pull-down node PD2 accurately, avoiding the problem of poor work stopping state of the second pull-down node control circuit 22 due to external interference with the pull-down node caused by potential floating of the pull-down node. Similarly, in the second output stage t2 of the second display period T2, the first pull-down node PD1 can also receive the low-level first control voltage EVN through the first pull-down node control transistor T211 so that the low-level voltage signal can be supplied to the second pull-down node PD2 accurately, avoiding the problem of poor work stopping state of the second pull-down node control circuit 22 due to external interference with the pull-down node caused by potential floating of the pull-down node.

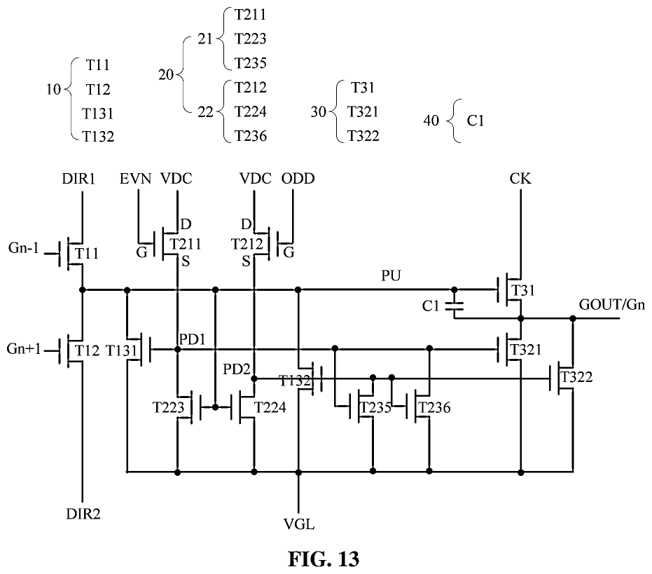

FIG. 13 is a diagram illustrating the structure of a gate driving unit according to one or more embodiments of this application. Referring to FIG. 13, on the basis of the embodiment shown in FIG. 10, in one or more embodiments, the first pull-down node control circuit 21 also includes a fifth pull-down node control transistor T235. The gate of the fifth pull-down node control transistor T235 is connected to the first pull-down node PD1. A second electrode, that is, the drain, of the fifth pull-down node control transistor T235 is connected to the second pull-down node PD2. A first electrode, that is, the source, of the fifth pull-down node control transistor T235 receives the first power signal. The second pull-down node control circuit 22 also includes a sixth pull-down node control transistor T236. The gate of the sixth pull-down node control transistor T236 is connected to the second pull-down node PD2. A second electrode, that is, the drain, of the sixth pull-down node control transistor T236 is connected to the first pull-down node PD1. A first electrode, that is, the source, of the sixth pull-down node control transistor T236 receives the first power signal.

As described earlier, in the embodiment shown in FIG. 10, the drain D of the first pull-down node control transistor T211 and the drain D of the second pull-down node control transistor T212 each receive the DC fixed voltage signal VDC, and the gate of the first pull-down node control transistor T211 and the gate of the second pull-down node control transistor T212 receive the voltage-variable first control voltage signal EVN and the voltage-variable second control voltage signal ODD respectively. Similarly, since the first control voltage signal EVN and the second control voltage signal ODD switch between the first voltage V1 and the second voltage V2, the first pull-down node control transistor T211 and the second pull-down node control transistor T212 are turned on alternately.

In the second output stage t2 of the second display period T2, the first pull-down node control transistor T211 and the third pull-down node control transistor T223 are both turned off so that the first pull-down node PD1 is floating and maintained at a low level. In the second output stage t2 of the first display period T2, the second pull-down node control transistor T212 and the fourth pull-down node control transistor T224 are both turned off so that the second pull-down node PD2 is floating and maintained at a low level. Thus, the first pull-down node control circuit 21 and the second pull-down node control circuit 22 continue working in the work stopping state under external interference, resulting in the problem of poor stop states of the two node control circuits.

In one or more embodiments, in the second output stage t2 of the first display period T1, for the second pull-down node control circuit 22, the second control voltage signal ODD is the low-level voltage signal VGL, the second pull-down node control circuit 22 stops working, the second pull-down node control transistor T212 is turned off, the pull-up node PU is at a low-level voltage signal, and the fourth pull-down node control transistor T224 is also turned off. At the same time, since the first control voltage signal EVN is the high-level voltage signal VGH in this stage, the first pull-down node control circuit 21 works, the first pull-down node control transistor T211 is turned on, and the first pull-down node PD1 receives the first control voltage signal EVN, that is, the high-level voltage signal VGH, through the first pull-down node control transistor T211. Since the gate of the fifth pull-down node control transistor T235 is electrically connected to the first pull-down node PD1, the fifth pull-down node control transistor T235 is turned on, and the second pull-down node PD2 receives the first power signal, that is, the low-level voltage signal VGL. Therefore, when the first pull-down node PD1 is at a high level, the second pull-down node PD2 can be controlled to receive the low-level voltage signal VGL, avoiding the problem that the second pull-down node PD2 floats when the first pull-down node PD1 is at a high-level voltage signal.

Similarly, in the second output stage t2 of the second display period T2, for the first pull-down node control circuit 21, the first control voltage signal EVN is the low-level voltage signal VGL, the first pull-down node control circuit 21 stops working, the first pull-down node control transistor T211 is turned off, the pull-up node PU is the low-level voltage signal, and the third pull-down node control transistor T223 is also turned off. At the same time, since the second control voltage signal ODD is the high-level voltage signal VGH in this stage, the second pull-down node control circuit 22 works, the second pull-down node control transistor T212 is turned on, and the second pull-down node PD2 receives the second control voltage signal ODD, that is, the high-level voltage signal. Since the gate of the sixth pull-down node control transistor T236 is electrically connected to the second pull-down node PD2, the sixth pull-down node control transistor T236 is turned on, and the first pull-down node PD1 receives the first power signal, that is, the low-level voltage signal VG, so that when the second pull-down node PD2 is at a high level, the first pull-down node PD1 can be controlled to receive the low-level voltage signal VGL, avoiding the problem that the first pull-down node PD1 floats when the second pull-down node PD2 is at a high-level voltage signal.

Referring to FIG. 9, FIG. 10, and FIG. 13, in one or more embodiments of this application, the pull-up node control circuit 10 may also include a third pull-up node control transistor T131 and a fourth pull-up node control transistor T132. A second electrode, that is, the drain, of the third pull-up node control transistor T131 is connected to the pull-up node PU, a first electrode, that is, the source, of the third pull-up node control transistor T131 receives the first power signal, and the gate of the third pull-up node control transistor T131 is connected to the first pull-down node PD1. A second electrode, that is, the drain, of the fourth pull-up node control transistor T132 is connected to the pull-up node PU, a first electrode, that is, the source, of the fourth pull-up node control transistor T132 receives the first power signal, and the gate of the fourth pull-up node control transistor T132 is connected to the second pull-down node PD2.

The third pull-up node control transistor T131 and the fourth pull-up node control transistor T132 are responsible for controlling the potential of the pull-up node PU through the potential of the pull-down node. In one or more embodiments, in the second stage t2 of the first display period T1, the first pull-down node PD1 is at a high level, and at this time, the third pull-up node control transistor T131 can be controlled to turn on so that the first power signal, that is, the low-level voltage signal VGL, is applied to the pull-up node PU so that after the storage capacitor C1 completes discharging, the pull-up node PU can be stabilized in a low-level state through the input low-level voltage signal VGL. Similarly, in the second stage t2 of the second display period T2, the second pull-down node PD2 is at a high level, and at this time, the fourth pull-up node control transistor T132 can be controlled to turn on so that the first power signal, that is, the low-level voltage signal VGL, is applied to the pull-up node PU so that after the storage capacitor C1 completes discharging, the pull-up node PU can be stabilized in a low-level state through the input low-level voltage signal VGL.

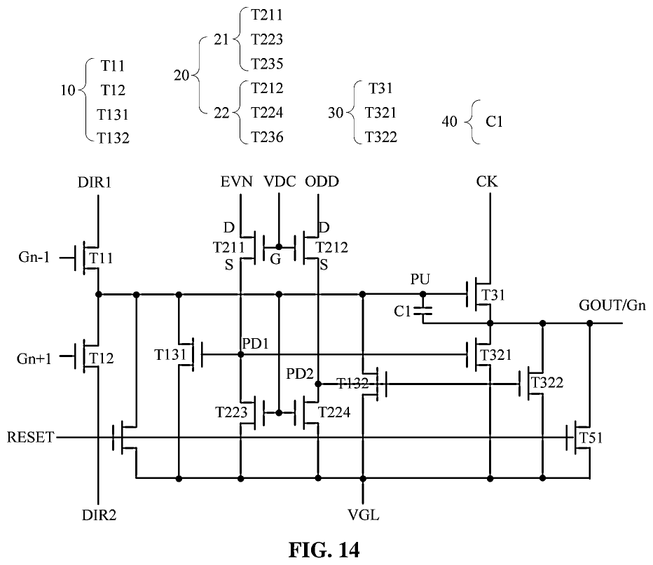

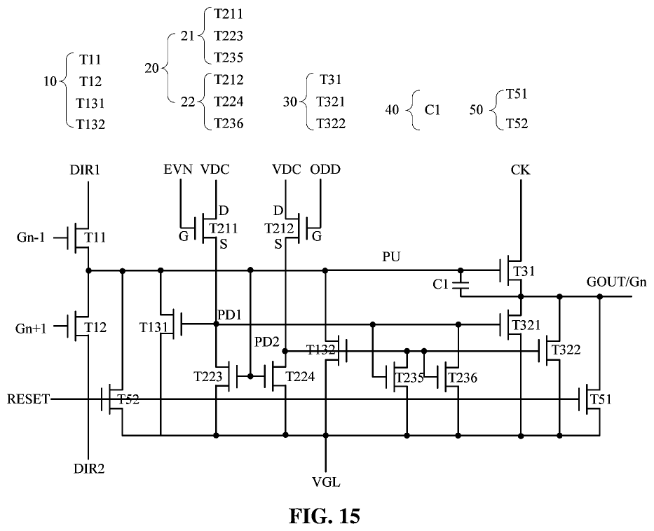

FIG. 14 and FIG. 15 are diagrams illustrating the structures of another two gate driving units according to one or more embodiments of this application. Referring to FIG. 14 and FIG. 15, in one or more embodiments, the gate driving unit in one or more embodiments of this application may also include a reset circuit 50 configured to control the gate driving signal output terminal GOUT and/or the pull-up node PU to reset under the control of the reset signal RESET. In one or more embodiments, the reset circuit includes an output terminal reset transistor T51 and/or a pull-up node reset transistor T52. A first electrode, that is, the source, of the output terminal reset transistor T51 is connected to the gate driving signal output terminal GOUT, and a first electrode, that is, the source, of the pull-up node reset transistor T52 is connected to the pull-up node PU. A second electrode, that is, the drain, of the output terminal reset transistor T51 and a second electrode, that is, the drain, of the pull-up node reset transistor T52 each receive the first power signal. The gate of the output terminal reset transistor T51 and the gate of the pull-up node reset transistor T52 each receive the reset signal RESET.

The first power signal may be a low-level voltage signal VGL. The reset circuit 50 is configured to control the pull-up node PU and the gate driving signal output terminal GOUT to reset through the reset signal RESET. In one or more embodiments, when the RESET signal is at a high level, the output terminal reset transistor T51 and the pull-up node reset transistor T52 can be controlled to turn on so that the first power signal, that is, the low-level voltage signal, is input to the gate driving signal output terminal GOUT and the pull-up node PU, thereby achieving the reset function.

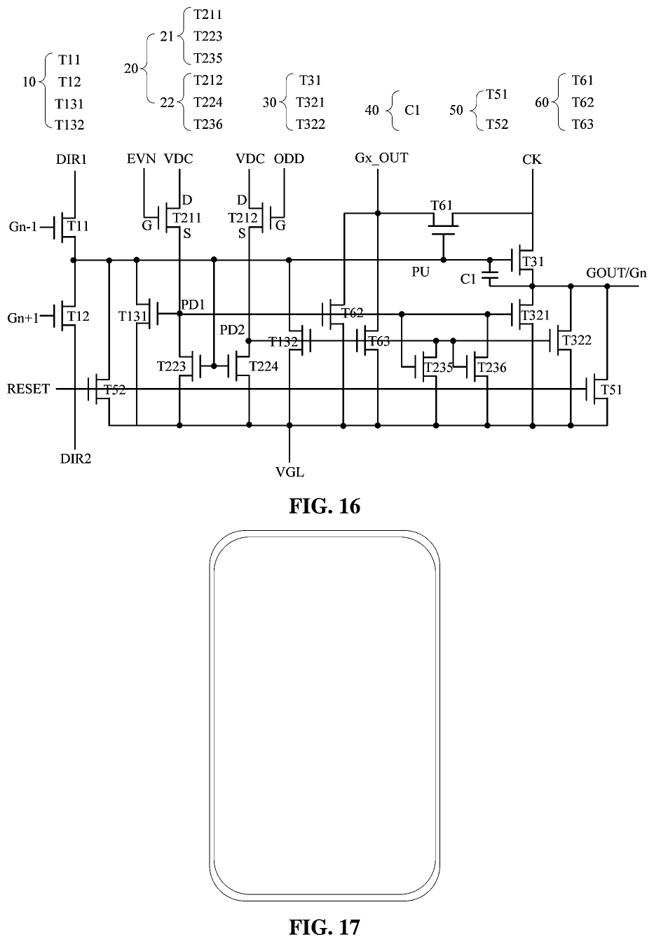

FIG. 16 is a diagram illustrating the structure of a gate driving unit according to one or more embodiments of this application. Referring to FIG. 16, in one or more embodiments, the gate driving unit in one or more embodiments of this application may also include a carry signal output circuit 60 configured to control the gate driving signal output by the carry signal output terminal Gx_OUT under the control of the voltage signal of the pull-up node PU, the voltage signal of the first pull-down node PD1, and the voltage signal of the second pull-down node PD2.

In one or more embodiments, the carry signal output circuit 60 includes a first carry control transistor T61, a second carry control transistor T62, and a third carry control transistor T63. A second electrode, that is, the drain, of the first carry control transistor T61 receives the clock signal CK, a first electrode, that is, the source, of the first carry control transistor T61 is connected to the carry signal output terminal Gx_OUT, and the gate of the first carry control transistor T61 is connected to the pull-up node PU. A second electrode, that is, the drain, of the second carry control transistor T62 and a second electrode, that is, the drain, of the third carry control transistor T63 are each connected to the carry signal output terminal Gx_OUT. A first electrode, that is, the source, of the second carry control transistor T62 and a first electrode, that is, the source, of the third carry control transistor T63 each receive the first power signal. The gate of the second carry control transistor T62 is connected to the first pull-down node PD1, and the gate of the third carry control transistor T63 is connected to the second pull-down node PD2.

The first power signal may be the low-level voltage signal VGL. In one or more embodiments, due to the same connection relationship, the first carry control transistor T61 actually functions the same as the first output control transistor T31, the second carry control transistor T62 functions the same as the first sub-output control transistor T32, and the third carry control transistor T63 functions the same as the first sub-output control transistor T32. In other words, the carry signal output circuit 60 is actually equal to the gate driving output circuit 30, and the carry signal Gx_OUT is completely consistent with the gate driving signal GOUT. The carry signal output circuit 60 is responsible for outputting the carry signal Gx_OUT as the current-stage gate driving signal GOUT and providing the carry signal Gx_OUT for the input terminal of the next-stage cascaded gate driving unit. That is, the (n−1)th-stage gate driving unit 100 outputs the carry signal Gx_OUT to the gate of the first pull-up node control transistor T11 of the nth-stage gate driving unit 100 to drive the next-stage gate driving unit 100 to work and achieve the sequential shifting of all stages of the gate driving units 100.

Based on the same inventive concept, one or more embodiments of this application provide a display device. FIG. 17 is a diagram illustrating the structure of a display device according to one or more embodiments of this application. Referring to FIG. 17, the display device includes the gate driving circuit (not shown) of any embodiment of this application. Therefore, the display device of one or more embodiments of this application has the beneficial effects of the display panel of any embodiment of this application. The beneficial effects are not described here again. Illustratively, the display device may be an electronic device such as a mobile phone, a computer, a smart wearable device (for example, a smart watch), or an in-vehicle display device. This is not limited in the embodiments of this application.

It is to be noted that the preceding are preferred embodiments of this application and the technical principles used therein. It is to be understood by those skilled in the art that this application is not limited to the embodiments described herein. Those skilled in the art can make various apparent modifications, adaptations, combinations, and substitutions without departing from the scope of this application. Therefore, though this application is described in detail through the preceding embodiments, this application is not limited to the preceding embodiments and may include other equivalent embodiments without departing from the concept of this application. The scope of this application is determined by the scope of the appended claims.

What is claimed is:

1. A gate driving circuit, comprising a plurality of gate driving units, a gate driving unit of the plurality of gate driving units comprises:
a pull-up node control circuit configured to control a potential of a pull-up node;
a pull-down node control circuit configured to control a potential of a pull-down node under control of a voltage signal of the pull-up node, a control voltage signal, and a fixed voltage signal; and
a gate driving output circuit configured to control a gate driving signal output by a gate driving signal output terminal of the gate driving unit under control of the voltage signal of the pull-up node and a voltage signal of the pull-down node;
wherein the pull-down node control circuit comprises a pull-down node control transistor, and a first electrode of the pull-down node control transistor is electrically connected to the pull-down node; and
wherein a gate of the pull-down node control transistor is configured to receive the control voltage signal, a second electrode of the pull-down node control transistor is configured to receive the fixed voltage signal, and the control voltage signal V and the fixed voltage signal VDC satisfy V<VDC for at least part of a time of a driving process of the gate driving circuit; or a gate of the pull-down node control transistor is configured to receive the fixed voltage signal, a second electrode of the pull-down node control transistor is configured to receive the control voltage signal, and the fixed voltage signal VDC and the control voltage signal V satisfy VDC<V for at least part of a time of a driving process of the gate driving circuit.

2. The gate driving circuit of claim 1, wherein
the pull-down node comprises a first pull-down node and a second pull-down node; the pull-down node control circuit comprises a first pull-down node control circuit and a second pull-down node control circuit; and the control voltage signal comprises a first control voltage signal and a second control voltage signal;
the first pull-down node control circuit is configured to control a potential of the first pull-down node under control of the voltage signal of the pull-up node, the first control voltage signal, and the fixed voltage signal;
the second pull-down node control circuit is configured to control a potential of the second pull-down node under control of the voltage signal of the pull-up node, the second control voltage signal, and the fixed voltage signal;
the first pull-down node control circuit comprises a first pull-down node control transistor, and a first electrode of the first pull-down node control transistor is electrically connected to the first pull-down node; and
a gate of the first pull-down node control transistor is configured to receive the first control voltage signal, and a second electrode of the first pull-down node control transistor is configured to receive the fixed voltage signal; or a gate of the first pull-down node control transistor is configured to receive the fixed voltage signal, and a second electrode of the first pull-down node control transistor is configured to receive the first control voltage signal;
the second pull-down node control circuit comprises a second pull-down node control transistor, and a first electrode of the second pull-down node control transistor is electrically connected to the second pull-down node; and
a gate of the second pull-down node control transistor is configured to receive the second control voltage signal, and a second electrode of the second pull-down node control transistor is configured to receive the fixed voltage signal; or a gate of the second pull-down node control transistor is configured to receive the fixed voltage signal, and a second electrode of the second pull-down node control transistor is configured to receive the second control voltage signal;
wherein the first control voltage signal and the second control voltage signal alternate between a first voltage and a second voltage over time, wherein one of the first voltage or the second voltage is the first voltage V1, and the other of the first voltage or the second voltage is the second voltage V2, wherein V1<V2; and
the gate driving output circuit is configured to control the gate driving signal output by the gate driving signal output terminal under control of the voltage signal of the pull-up node, a voltage signal of the first pull-down node, and a voltage signal of the second pull-down node.

3. The gate driving circuit of claim 2, wherein the fixed voltage signal VDC, the first voltage V1, and the second voltage V2 satisfy V1<VDC<V2.

4. The gate driving circuit of claim 2, wherein
the first pull-down node control circuit further comprises a third pull-down node control transistor, and the second pull-down node control circuit further comprises a fourth pull-down node control transistor;
the gate of the first pull-down node control transistor and the gate of the second pull-down node control transistor are each configured to receive the fixed voltage signal, the second electrode of the first pull-down node control transistor is configured to receive the first control voltage signal, and the second electrode of the second pull-down node control transistor is configured to receive the second control voltage signal; and
a second electrode of the third pull-down node control transistor is connected to the first pull-down node, and a second electrode of the fourth pull-down node control transistor is connected to the second pull-down node; and a gate of the third pull-down node control transistor and a gate of the fourth pull-down node control transistor are each connected to the pull-up node, and a first electrode of the third pull-down node control transistor and a first electrode of the fourth pull-down node control transistor are each configured to receive a first power signal.

5. The gate driving circuit of claim 2, wherein
the first pull-down node control circuit further comprises a third pull-down node control transistor, and the second pull-down node control circuit further comprises a fourth pull-down node control transistor;
the second electrode of the first pull-down node control transistor and the second electrode of the second pull-down node control transistor are each configured to receive the fixed voltage signal, the gate of the first pull-down node control transistor is configured to receive the first control voltage signal, and the gate of the second pull-down node control transistor is configured to receive the second control voltage signal; and
a second electrode of the third pull-down node control transistor is connected to the first pull-down node, and a second electrode of the fourth pull-down node control transistor is connected to the second pull-down node; and a gate of the third pull-down node control transistor and a gate of the fourth pull-down node control transistor are each connected to the pull-up node, and a first electrode of the third pull-down node control transistor and a first electrode of the fourth pull-down node control transistor are each configured to receive a first power signal.

6. The gate driving circuit of claim 5, wherein
the first pull-down node control circuit further comprises a fifth pull-down node control transistor, a gate of the fifth pull-down node control transistor is connected to the first pull-down node, a second electrode of the fifth pull-down node control transistor is connected to the second pull-down node, and a first electrode of the fifth pull-down node control transistor is configured to receive the first power signal; and
the second pull-down node control circuit further comprises a sixth pull-down node control transistor, a gate of the sixth pull-down node control transistor is connected to the second pull-down node, a second electrode of the sixth pull-down node control transistor is connected to the first pull-down node, and a first electrode of the sixth pull-down node control transistor is configured to receive the first power signal.

7. The gate driving circuit of claim 4, wherein at least one of the following configurations is satisfied:
a ratio of a width-to-length ratio of the third pull-down node control transistor to a width-to-length ratio of the first pull-down node control transistor ranges from 1.6 to 2; or
a ratio of a width-to-length ratio of the fourth pull-down node control transistor to a width-to-length ratio of the second pull-down node control transistor ranges from 1.6 to 2.

8. The gate driving circuit of claim 2, wherein
the plurality of gate driving units are cascaded in sequence;
the pull-up node control circuit comprises a first pull-up node control transistor and a second pull-up node control transistor;
a second electrode of the first pull-up node control transistor is configured to receive a forward scan control signal, a first electrode of the first pull-up node control transistor is connected to the pull-up node, and a gate of the first pull-up node control transistor is configured to receive a gate driving signal output by a gate driving signal output terminal of a cascaded previous-stage gate driving unit of the plurality of gate driving units;
a second electrode of the second pull-up node control transistor is configured to receive a reverse scan control signal, a first electrode of the second pull-up node control transistor is connected to the pull-up node, and a gate of the second pull-up node control transistor is configured to receive a gate driving signal output by a gate driving signal output terminal of a cascaded next-stage gate driving unit of the plurality of gate driving units; and
in a same gate driving unit of the plurality of gate driving units, a polarity of the forward scan control signal is opposite to a polarity of the reverse scan control signal.

9. The gate driving circuit of claim 8, wherein
the pull-up node control circuit further comprises a third pull-up node control transistor and a fourth pull-up node control transistor;
a second electrode of the third pull-up node control transistor is connected to the pull-up node, a first electrode of the third pull-up node control transistor is configured to receive a first power signal, and a gate of the third pull-up node control transistor is connected to the first pull-down node; and
a second electrode of the fourth pull-up node control transistor is connected to the pull-up node, a first electrode of the fourth pull-up node control transistor is configured to receive a first power signal, and a gate of the fourth pull-up node control transistor is connected to the second pull-down node.

10. The gate driving circuit of claim 1, wherein
the gate driving output circuit comprises a first output control transistor and a second output control transistor;
a second electrode of the first output control transistor is configured to receive a clock signal, a first electrode of the first output control transistor is connected to the gate driving signal output terminal, and a gate of the first output control transistor is connected to the pull-up node; and
a second electrode of the second output control transistor is connected to the gate driving signal output terminal, a first electrode of the second output control transistor is configured to receive a first power signal, and a gate of the second output control transistor is connected to the pull-down node.

11. The gate driving circuit of claim 1, wherein the gate driving output circuit further comprises an energy storage circuit, and the energy storage circuit is connected to the pull-up node and configured to maintain the potential of the pull-up node.

12. The gate driving circuit of claim 11, wherein the energy storage circuit comprises a storage capacitor, a first plate of the storage capacitor is connected to the pull-up node, and a second plate of the storage capacitor is connected to the gate driving signal output terminal.

13. The gate driving circuit of claim 1, further comprising a reset circuit, the reset circuit is configured to control at least one of the gate driving signal output terminal or the pull-up node to reset under control of a reset signal.

14. The gate driving circuit of claim 13, wherein
the reset circuit comprises at least one of an output terminal reset transistor or a pull-up node reset transistor; and
a first electrode of the output terminal reset transistor is connected to the gate driving signal output terminal, and a first electrode of the pull-up node reset transistor is connected to the pull-up node; and a second electrode of the output terminal reset transistor and a second electrode of the pull-up node reset transistor are each configured to receive a first power signal, and a gate of the output terminal reset transistor and a gate of the pull-up node reset transistor are each configured to receive the reset signal.

15. The gate driving circuit of claim 2, further comprising a carry signal output circuit, the carry signal output circuit is configured to control a gate driving signal output by a carry signal output terminal under the control of the voltage signal of the pull-up node, the voltage signal of the first pull-down node, and the voltage signal of the second pull-down node.

16. The gate driving circuit of claim 15, wherein
the carry signal output circuit comprises a first carry control transistor, a second carry control transistor, and a third carry control transistor;
a second electrode of the first carry control transistor is configured to receive a clock signal, a first electrode of the first carry control transistor is connected to the carry signal output terminal, and a gate of the first carry control transistor is connected to the pull-up node; and
a second electrode of the second carry control transistor and a second electrode of the third carry control transistor are each connected to the carry signal output terminal, and a first electrode of the second carry control transistor and a first electrode of the third carry control transistor are each configured to receive a first power signal; and a gate of the second carry control transistor is connected to the first pull-down node, and a gate of the third carry control transistor is connected to the second pull-down node.

17. A driving method of a gate driving circuit, the method is applied to the gate driving circuit of claim 1, and a driving process of the gate driving circuit comprises a first output stage and a second output stage; and
the driving method comprises:
in the first output stage, controlling, by the pull-up node control circuit, the potential of the pull-up node to be an active level; and controlling, by the gate driving output circuit, the gate driving signal output by the gate driving signal output terminal to be a first gate driving signal under the control of the voltage signal of the pull-up node; and
in the second output stage, controlling, by the pull-down node control circuit, the potential of the pull-down node to be an active level under the control of the voltage signal of the pull-up node, the control voltage signal, and the fixed voltage signal; and controlling, by the gate driving output circuit, the gate driving signal output by the gate driving signal output terminal to be a second gate driving signal under the control of the voltage signal of the pull-down node.

18. The driving method of claim 17, wherein
the pull-down node comprises a first pull-down node and a second pull-down node; the pull-down node control circuit comprises a first pull-down node control circuit and a second pull-down node control circuit; and the control voltage signal comprises a first control voltage signal and a second control voltage signal;
the first pull-down node control circuit is configured to control a potential of the first pull-down node under control of the voltage signal of the pull-up node, the first control voltage signal, and the fixed voltage signal;
the second pull-down node control circuit is configured to control a potential of the second pull-down node under control of the voltage signal of the pull-up node, the second control voltage signal, and the fixed voltage signal;
the first pull-down node control circuit comprises a first pull-down node control transistor, and a first electrode of the first pull-down node control transistor is electrically connected to the first pull-down node; and a gate of the first pull-down node control transistor is configured to receive the first control voltage signal, and a second electrode of the first pull-down node control transistor is configured to receive the fixed voltage signal; or a gate of the first pull-down node control transistor is configured to receive the fixed voltage signal, and a second electrode of the first pull-down node control transistor is configured to receive the first control voltage signal;
the second pull-down node control circuit comprises a second pull-down node control transistor, and a first electrode of the second pull-down node control transistor is electrically connected to the second pull-down node; and a gate of the second pull-down node control transistor is configured to receive the second control voltage signal, and a second electrode of the second pull-down node control transistor is configured to receive the fixed voltage signal; or a gate of the second pull-down node control transistor is configured to receive the fixed voltage signal, and a second electrode of the second pull-down node control transistor is configured to receive the second control voltage signal; wherein the first control voltage signal and the second control voltage signal alternate between a first voltage and a second voltage over time, wherein one of the first voltage or the second voltage is the first voltage V1, and the other of the first voltage or the second voltage is the second voltage V2, wherein V1<V2;
the gate driving output circuit is configured to control the gate driving signal output by the gate driving signal output terminal under control of the voltage signal of the pull-up node, a voltage signal of the first pull-down node, and a voltage signal of the second pull-down node;
the driving process of the gate driving circuit comprises a first display period and a second display period; and the first display period and the second display period each comprise the first output stage and the second output stage; and
the driving method comprises:
in the first output stage of the first display period and the first output stage of the second display period, controlling, by the pull-up node control circuit, the potential of the pull-up node to be an active level; and controlling, by the gate driving output circuit, the gate driving signal output by the gate driving signal output terminal to be the first gate driving signal under the control of the voltage signal of the pull-up node;
in the second output stage of the first display period, controlling, by the first pull-down node control circuit, the potential of the first pull-down node to be an active level under the control of the voltage signal of the pull-up node, the first control voltage signal, and the fixed voltage signal;
controlling, by the gate driving output circuit, the gate driving signal output by the gate driving signal output terminal to be the second gate driving signal under the control of the voltage signal of the first pull-down node; and
in the second output stage of the second display period, controlling, by the second pull-down node control circuit, the potential of the second pull-down node to be an active level under the control of the voltage signal of the pull-up node, the second control voltage signal, and the fixed voltage signal; and controlling, by the gate driving output circuit, the gate driving signal output by the gate driving signal output terminal to be the second gate driving signal under the control of the voltage signal of the second pull-down node.

19. A display panel, comprising the gate driving circuit of claim 1.

20. A display device, comprising the display panel of claim 19.
